(19) United States
(12) Patent Application Publication
(10) Pub. No.: US 2010/0262318 A1
(43) Pub. Date: Oct. 14, 2010

(54) Electronic flight bag user interface system

(75) Inventor: Jeffrey J. Ariens, Punta Gorda, FL (US)

Correspondence Address: DENNIS G. LAPOINTE;LAPOINTE LAW GROUP, PL, PO BOX 1294, TARPON SPRINGS, FL, 34688-1294, US

(73) Assignee: J. Ariens & Associates, Inc., Punta Gorda, FL (US)

(21) Appl. No.: 11/803,959

(22) Filed: May 16, 2007

(51) Int. Cl. G05D 1/00

(52) U.S. Cl. 701/3

(57) ABSTRACT

An electronic flight bag user interface system that has a multi-function flight information display unit in electronic communication with a remote processing unit. The processing unit is in electronic communication with an aircraft avionics system. Pre-loaded flight information allows the user to access and display flight information on the display unit in digital electronic format, including charts and plates, flight manuals, weather information, camera viewing information, ship library information, and revision status of software programmed in the processing unit and revision status of pre-loaded charts, plates and manuals. The system operates on a single or a dual operating system platform, a Windows® based operating system and the other based on a DO178B certified operating system.

### FIELD OF THE INVENTION

The invention relates to a user interface system for use as an electronic flight bag.

### BACKGROUND OF THE INVENTION

An Electronic Flight Bag (EFB) is categorized in Federal Aviation Administration (FAA) Advisory Circular AC120-76A. The FAA describes three classes of hardware (Class 1, 2, 3) and three classes of software (A, B, C). Class 1 hardware is an off the shelf computer or tablet in a portable design. Class 2 hardware is an installed but removable device and Class 3 hardware is an installed device that meets avionics hardware requirements such as Technical Standards Document RTCA/DO160, “Environmental Conditions and Test Procedures for Airborne Equipment” currently available from RTCA, 1828 L Street NW, Suite 805, Washington, D.C., 20036. The software type A is software that runs on standard windows and has no software certification requirements. The type B software runs on Windows, has no software certification requirements and can pan, zoom and center charts. Type C software requires software certification of RTCA/DO178B, “Software Considerations in Airborne Systems and Equipment Certification.” The RTCA/DO178B (also referred to hereinafter as DO178B) certification is such that it is impossible or impractical to certify an off the shelf windows operating system to these requirements.

Certain EFB applications such as the display of own-ship position, aircraft traffic information and communication with other more critical components on an aircraft require Type C and DO178B certifications.

Prior art EFB hardware requires a user to select either a device that has a standard windows operating system and is approved for type A and B software or alternatively an EFB that has a DO178B certified operating system to support type C applications. Prior art by Astronautics Corporation offered a device with two separate processors, one running Windows for type A and B applications, the other running a DO178B certified operating system. This approach is very expensive.

Prior art in EFB charting software is offered by Jeppesen and the FAA NACO. Prior art allows the preloading of some number of pages into a single clipboard for retrieval but does not offer the logical arrangement of data for each phase of flight, that is, Origin, Destination, Alternate and Enroute.

### SUMMARY OF THE INVENTION

This invention describes a user interface on a Multi Function Flight Information Display Unit also known as an Electronic Flight Bag or EFB and hereinafter referred to as the device. The device is used in the cockpit of an aircraft to electronically display the thousands of charts, plates manuals and data that was previously handled in paper. The description of the device and its operational characteristics is described hereinafter in the detailed summary of the invention section in relation to the accompanying drawings for a better understanding of the benefits and uses of the invention.

This invention makes use of an EFB hardware device with a single processor running two separate operating systems. The windows environment allows for easy addition of type A and B software applications. The DO178B operating system can act in one of two ways. First, as a platform to run type C applications and second, as an integrity monitor to guarantee the required level of integrity that the program running on Windows is displaying the appropriate information and guarantee with the required degree of certainty that if incorrect, hazardous or misleading information is displayed the monitor flags the data as invalid.

This approach allows for a cost effective EFB solution that has the advantages of hosting Class A, B and C applications. The essence of the patent is the user interface that is designed for the easy manipulation of flight charts and plates in an electronic format.

The introduction of EFBs (Electronic Flight Bags) has provided a means for pilots to be able to replace their paper charts with digital equivalents. The key to making this change as easy as possible is a simple intuitive method for the organization of the charts and plates used for a particular flight.

A pilot may have a collection of as many as 14,000 plates and hundreds of charts. Only certain ones are readily needed to operate a particular flight. This software design and user interface allows the simple selection of the charts and plates needed for a flight and a means to organize them and provide the necessary display of the required information, usually with just one touch.

Typically, data is organized with a four file system. One file for Origin, Destination, Enroute and Alternate(s).

The Origin and destination airports are entered either manually by the pilot or automatically by the Flight Management System (FMS). Individual plates for these airports are selected through submenus to allow them to be stored in quick reference tabs. Once stored the pilot can view a plate and simultaneously see the tabs for quick selection of the other necessary plates.

This system of organization makes logical sense to a pilot since it follows a method similar to what he was used to in the paper environment.

The display unit is generally connected to a remote processor unit using LVDS or fiber optic connections and the system operates as an airline avionics system rather than a Personal Computer (PC). The invention is powered with aircraft power, and has an “on/off” button for selectively turning the display off.

### BRIEF DESCRIPTION OF THE DRAWINGS

The patent or application file contains at least one drawing executed in color. Copies of this patent with color drawing(s) will be provided by the Patent and Trademark Office upon request and payment of necessary fee.

In the accompanying drawings:

FIG. 1 is a general depiction of the device depicting six optional selection, including Revision Status, Charts and Plates, Flight Papers, Ships Library, Weather and Cameras;

FIG. 2 is a depiction of the device after Charts and Plates has been selected in FIG. 1, wherein Origin, Enroute, Destination and Alternate are selectable;

FIG. 3 is an example of a chart displayed in which an airport is selectable, in this case, an origin airport is selected as Logan Airport by way of example;

FIG. 4 is an example of a display on the inventive device where an origin airport has been selected and optional selections for that airport are further displayed;

FIG. 5 is an example of an airport runway diagram, in this case for Logan Airport;

FIG. 6 is a zoomed in diagram taken from FIG. 5;

FIG. 7 is a rotated diagram of FIGS. 5 and 6;

FIG. 8 is an example of an Enroute Chart Display depiction;

FIG. 9 is an example of an Enroute Display in Plan Mode, in this case, depicting the World in general;

FIG. 10 is an example of a Plan Mode display depicting a specific region such as North America (parts of Canada, the United States and Mexico);

FIG. 11 is an example of the Enroute (Plan) diagram depicting a selected highlighting feature;

FIG. 12 is an example of a chart showing takeoff minimum data for a selected airport, in this case, Logan Airport in Boston;

FIG. 13 is an example of a diagram with the option of obtaining runway notes; and

FIG. 14 is a conceptual schematic of one example of the display unit in electronic communication with a processing unit and ship's avionics system.

### DETAILED DESCRIPTION OF THE INVENTION

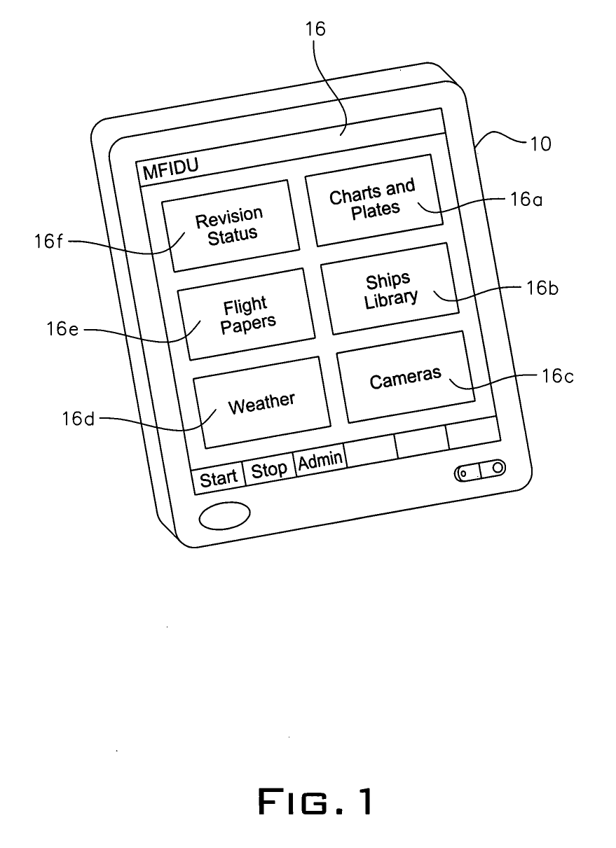

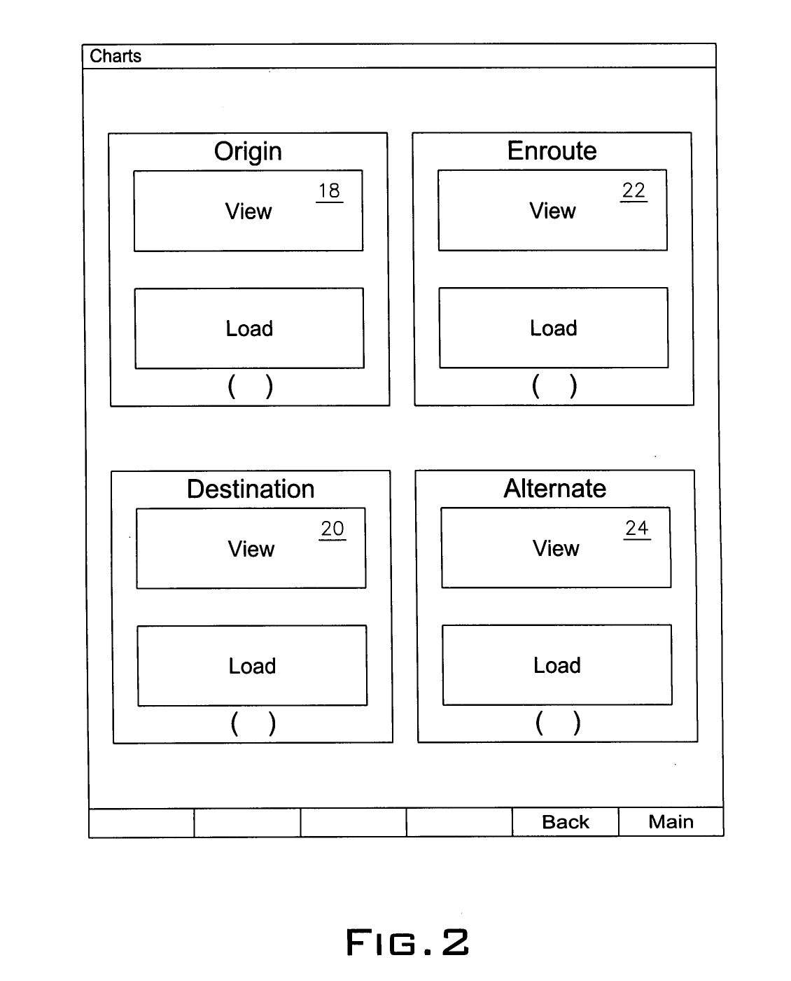

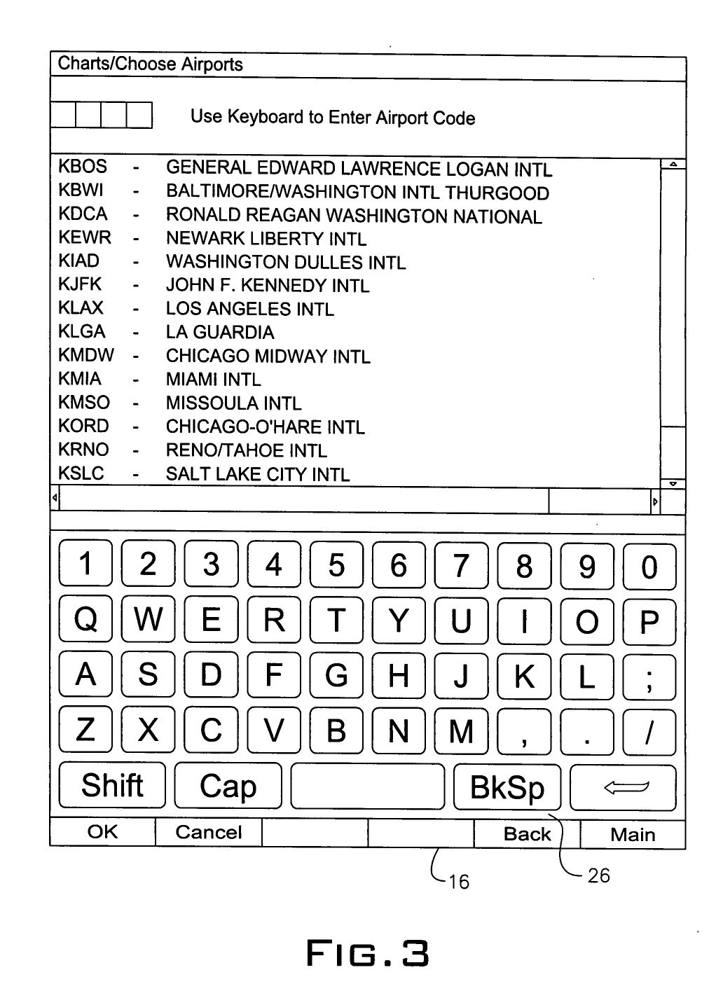

The inventive device is depicted in FIG. 1 and is generally depicted as numeral 10. The invention 10 is the unique user interface that is designed to allow for easy intuitive manipulation of the necessary charts and plates for each phase of flight. The digital representation of the charts and plates are organized in four folders (Origin, Destination, Enroute and Alternate) as depicted in FIG. 2. Entering the load area of each of these folders opens up a virtual keyboard to allow selection of an airport as depicted in FIG. 3 by way of example.

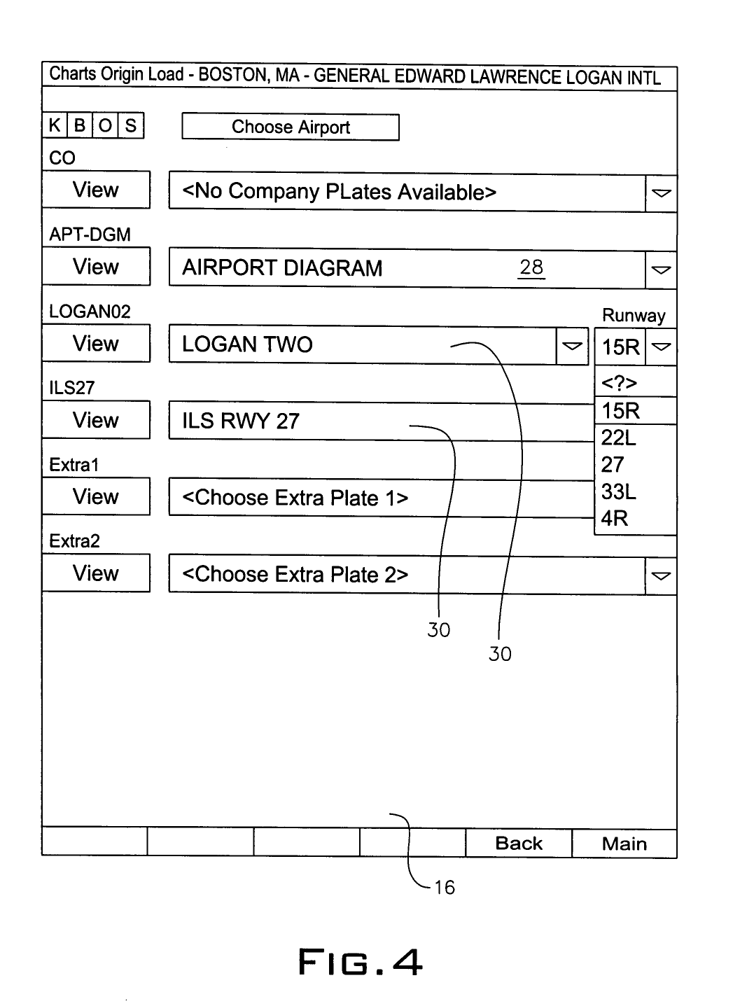

By way of example on how the invention 10 works operationally, upon selection for an origin airport such as Logan Airport in Boston, Mass., six or more semitransparent tabs can be loaded to allow for quick and easy user selection of the necessary charts and plates for each phase of the flight. See FIG. 4 displaying the Boston airport choices such as runways, including instrument landing system (ILS) designated runway and airport diagram.

Again by way of example of the starting operational procedure using the interface device 10. A user touches the Charts button on the Main Menu to display the Charts menu, the starting point for accessing all charts and terminal procedure plates needed for a flight.

The Charts menu is divided into the four sections of the flight: the Origin, the Destination, the Enroute section, and the Alternate airport that might be used during the flight. (The pilot is free to use the alternate area for viewing whatever terminal procedure plates he or she wishes.)

Before a flight, the pilot, with the help of the FMS, selects the Origin, Destination and Alternate airports and chooses terminal procedure plates for each of these selected airports. Once the airports are selected, the EFB will select the appropriate Enroute chart(s) to cover the route.

The Back Button is touched to return to the previous screen and the Main button can be touched to return to the EFB main menu.

### Airport Clipboards

Each airport associated with a flight (Origin, Destination and Alternate) has its own clipboard. (The Enroute section of the flight does not have a clipboard, because there is no airport associated with it.) An airport may be selected for each clipboard.

### Selecting Airports

From the Charts menu, touch the Load button for any airport associated with the flight. This opens the clipboard for that section of the flight. Touch the Choose Airport button at the top of the screen. This opens the airport selection screen. The airport selection screen lists all airports served by company planes. Touch the name of the airport on the list or type the four-letter code of the airport using the virtual keyboard. The code will display in the boxes above the airport list. Touch the “Enter” key when finished. The airport code will display at the top of the Airport Clipboard.

### Selecting Terminal Procedure Plates

Once the airport is selected, some terminal procedure plates, such as the airport diagram, will automatically be selected. If there is only one plate of a certain type available, it will also be selected automatically. All other plates must be selected by the pilot. Each airport clipboard keeps the terminal procedure plates selected for the each airport organized for easy access during the flight. Within the Origin, Destination and Alternate clipboards, the following Terminal Procedure plate types can be selected:
STARs (Standard Terminal Arrivals)
IAPs (Instrument Approach Procedures)
APDs (Airport Diagrams, also referred to as Taxi Diagrams)
DPs (Departure Procedures)
Airline provided data (mnemonic COM, meaning Company, is used for these)

The four-letter airport code of the airport selected by the pilot displays at the top of the screen. Below the airport code are several drop-down lists showing all terminal procedure plates for that airport, organized by type:

CO (Company): Select company information, such as takeoff minimums and alternate minimums, if any are available.

APT-DGM: Airport Diagram of the selected airport. This is selected automatically once an airport is selected.

Runway: Select a runway, if more than one is available.

Depart/Arrival: For the Origin clipboard, this line will display the Departure procedure; for the Destination and Alternative clipboards, it will display the Arrival procedure.

Extra Plate 1/Extra Plate 2: “Extra” plates chosen by the pilot. These may be left empty. To select a plate:

1. Touch the drop-down list for the plate type to be selected.

2. Scroll through the list to find the plate. Touch the name of the plate to select it.

Each airport clipboard provides the option of two “Extra” plates. The pilot can fill these fields if desired or leave them blank.

Touch the View button next to any plate type to view that plate. Touch the Back button to return to the Charts Menu.

Once all terminal procedure plates are selected, touch Main to return to the Charts Main Menu. Make sure to repeat this process for each airport associated with the flight.

### Terminal Procedure Plate Display

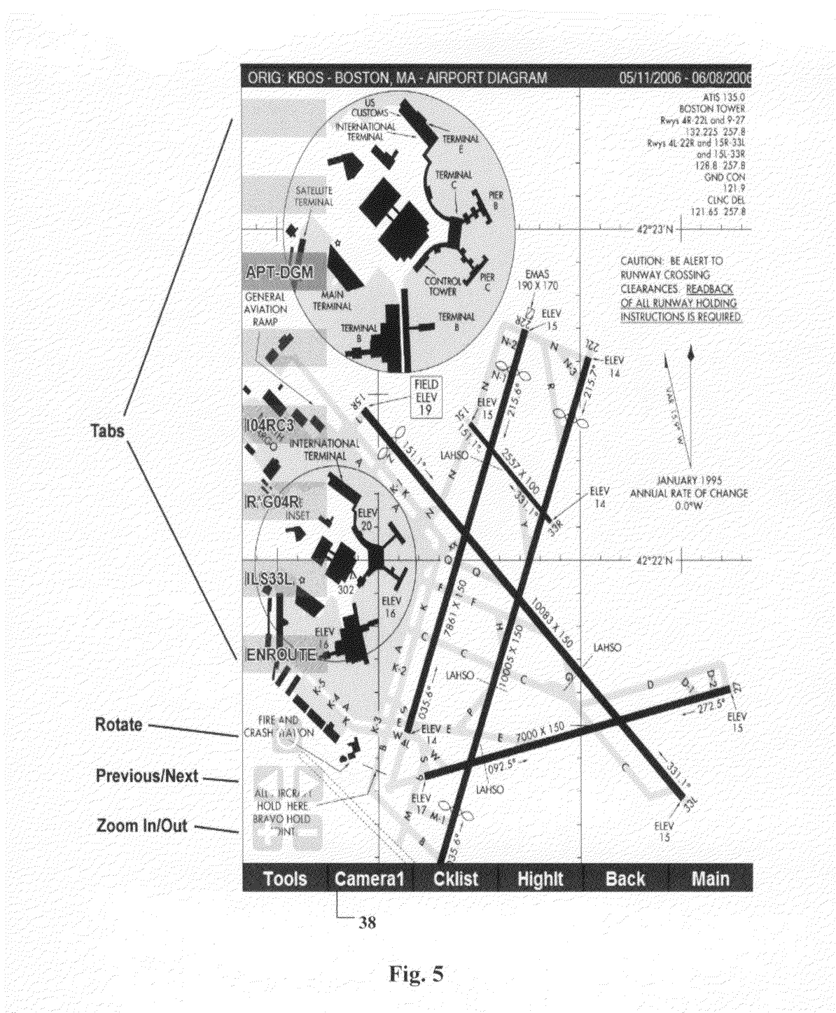

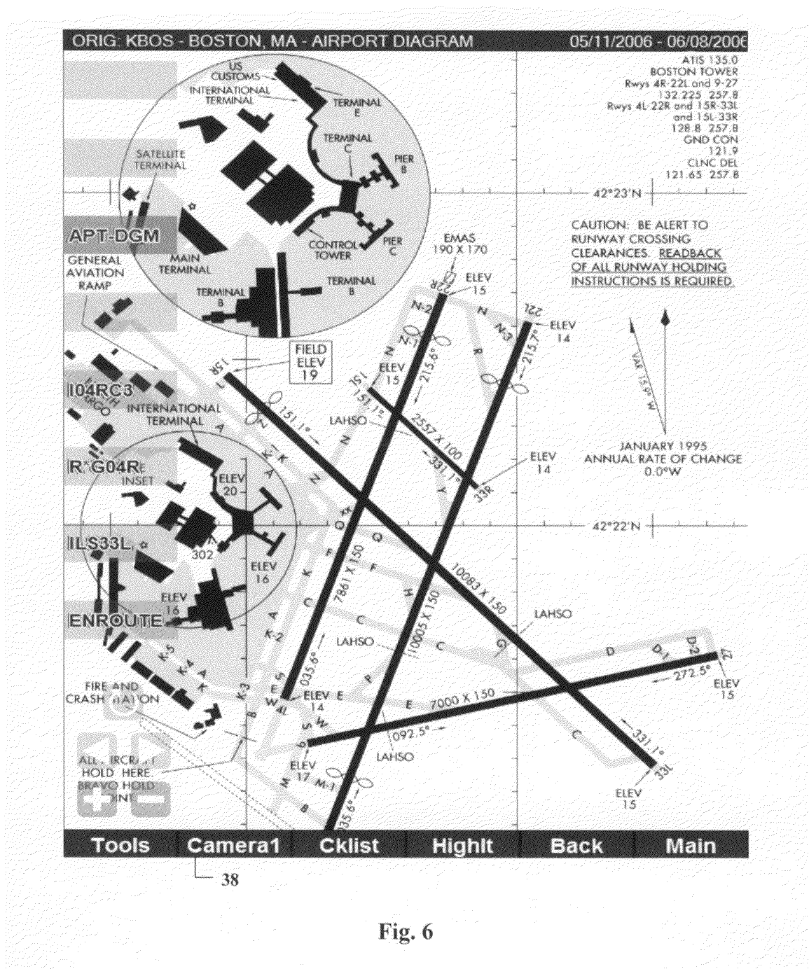

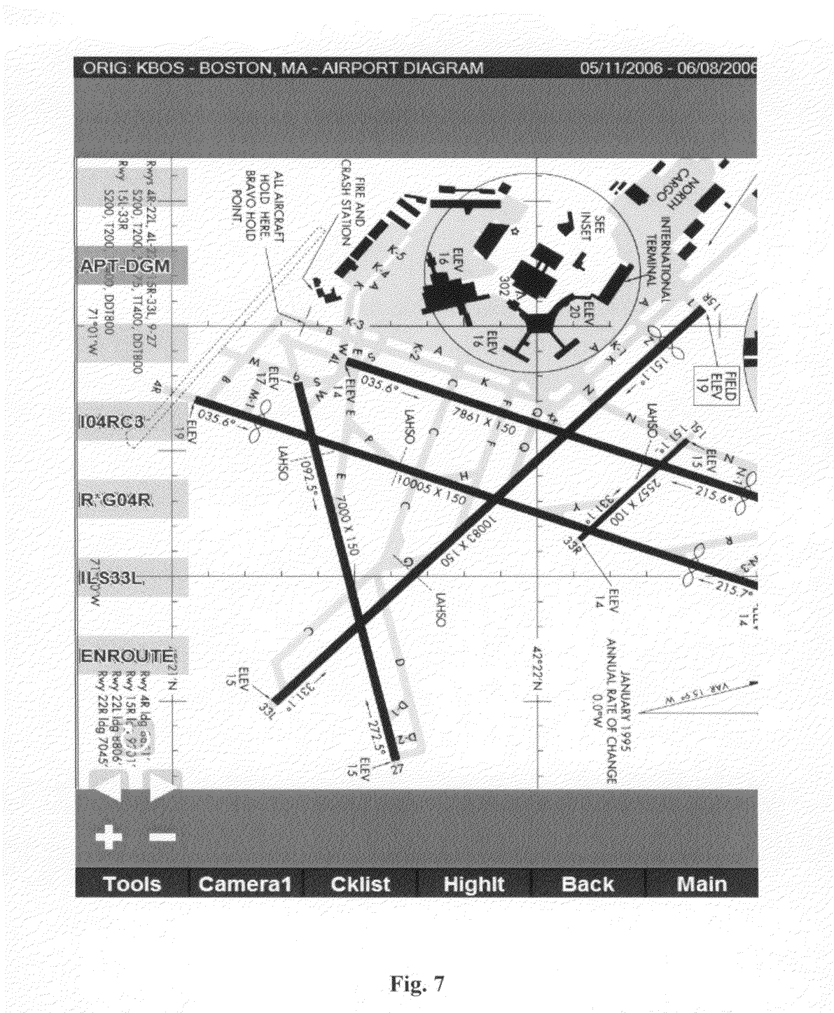

To display a terminal procedure plate, touch the View button for any airport on the Charts Main menu. This will display the Airport Diagram for that airport (see FIGS. 5-7).

As depicted in FIGS. 5-7, selective Buttons are available for manipulating the display image.

### Button Controls

Tabs: There are eight translucent tabs located along the left side of the plate display. Touch any of these tabs to switch to different components associated with this flight. This may mean switching to another plate within the collection of plates for a single airport, or switching from plates to Enroute charts. Procedure plate tab assignments for Origin, Destination and Alternate airports are always the same. The first six tabs have fixed assignments: Airport Clipboard, Company Info, Airport (Taxi) Diagram, Arrival or Departure Procedure, Approach Procedure. The sixth and seventh tabs are for the extra plates chosen by the pilot. If no extra plates are chosen, the tabs will be blank. The eighth tab is used to switch from viewing plates to viewing Enroute charts. Tabs can be hidden from view by touching the Tools button at the bottom of the display.

Rotate: The Rotate button rotates the image +/−90 degrees and resets the zoom level and panning position to the default setting. Touch the rotate button repeatedly to toggle between 0 and 90 degrees of clockwise rotation. Terminal procedure plates are printed in such a way that no other position (180° or 270°) would be useful to display, because labels would be upside down or sideways.

Previous/Next: The Previous/Next arrow buttons allow the pilot to browse through sets of multi-page plates. Multi-page plates are quite common for arrival and departure procedures and company info pages. Touch the Next tab repeatedly to cycle through all the pages of the current plate. For a two-page plate, the Next tab will toggle back and forth between the two pages. The Next tab is also used to view takeoff minimums. Touch the airport diagram tab, then touch the Next tab, to see takeoff minimums.

Zoom in/out: The plus (+) and minus (−) buttons are used to move in for a closer look or move out for a wider view. The zooming varies in a series of small steps with the highest zoom level 4 times bigger than the lowest zoom level. Press and hold a finger on the plus or minus button for a continuous and smooth zoom.

Panning: To see other parts of the plate, touch and drag the image to the desired position.

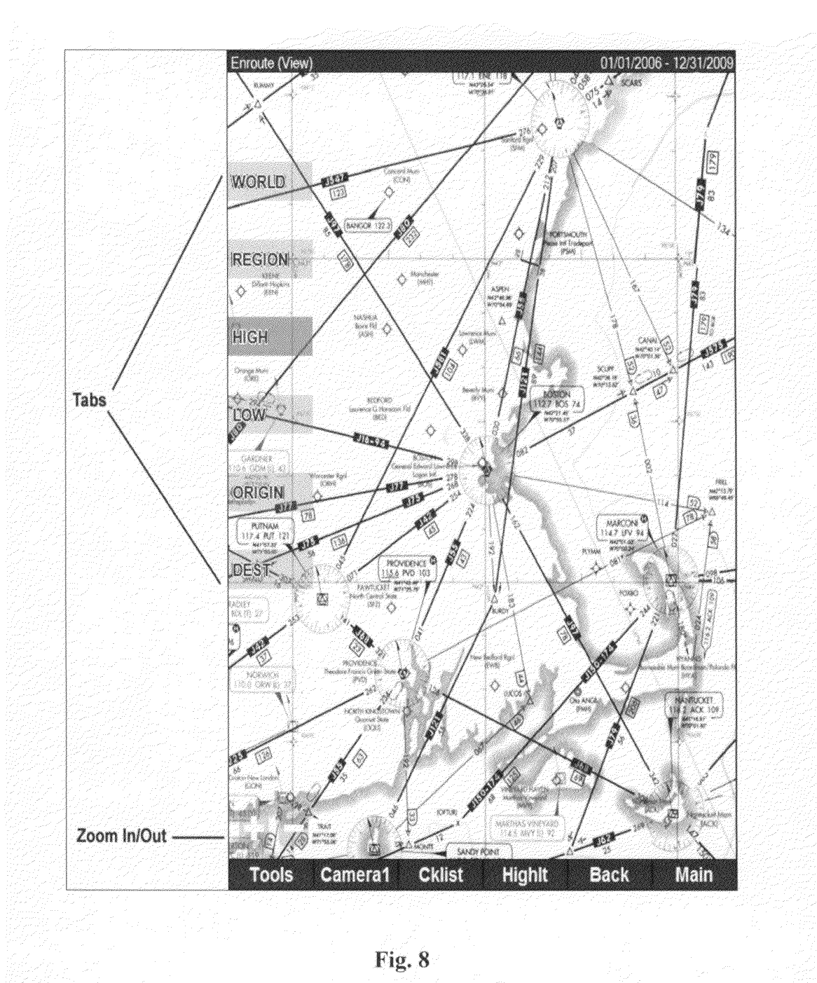

FIG. 8 depicts an Enroute Chart Display. When an Enroute chart displays in View Mode, the aircraft's position is marked with a colored arrow such as purple and is centered on the chart. As the aircraft moves, the icon stays in the center of the display and the chart moves beneath it. Touch the Enroute View button on the Charts Main Menu to display the Enroute chart. The chart will open centered on the aircraft's location.

### Plan Mode

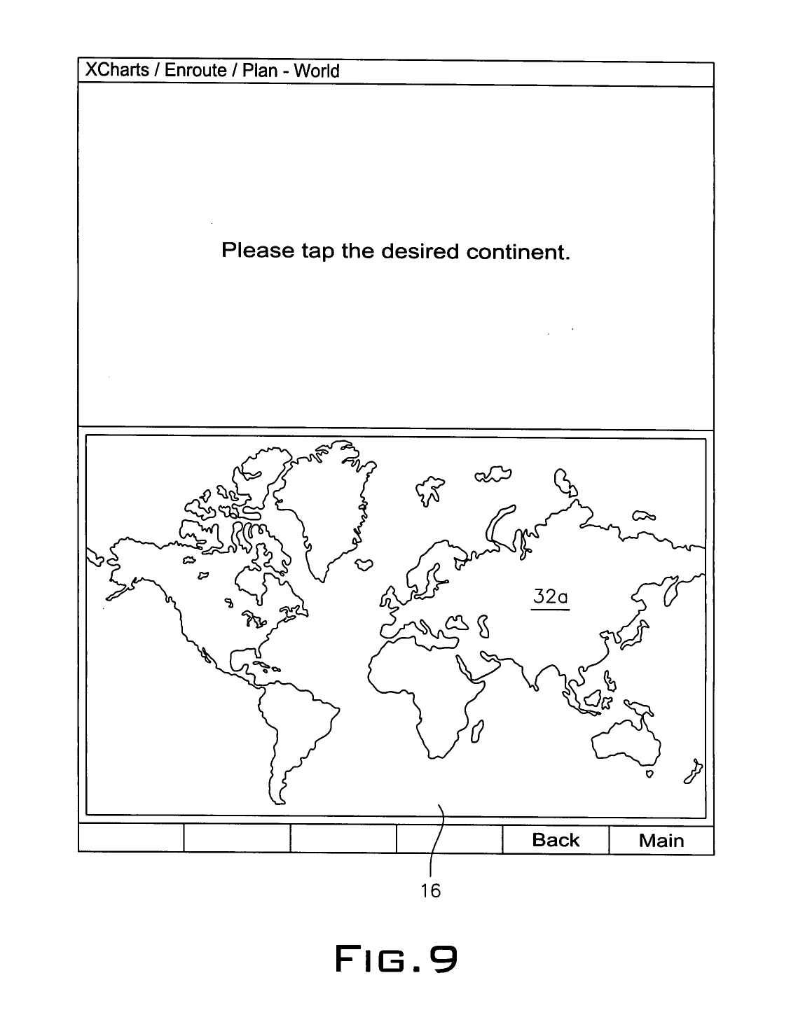

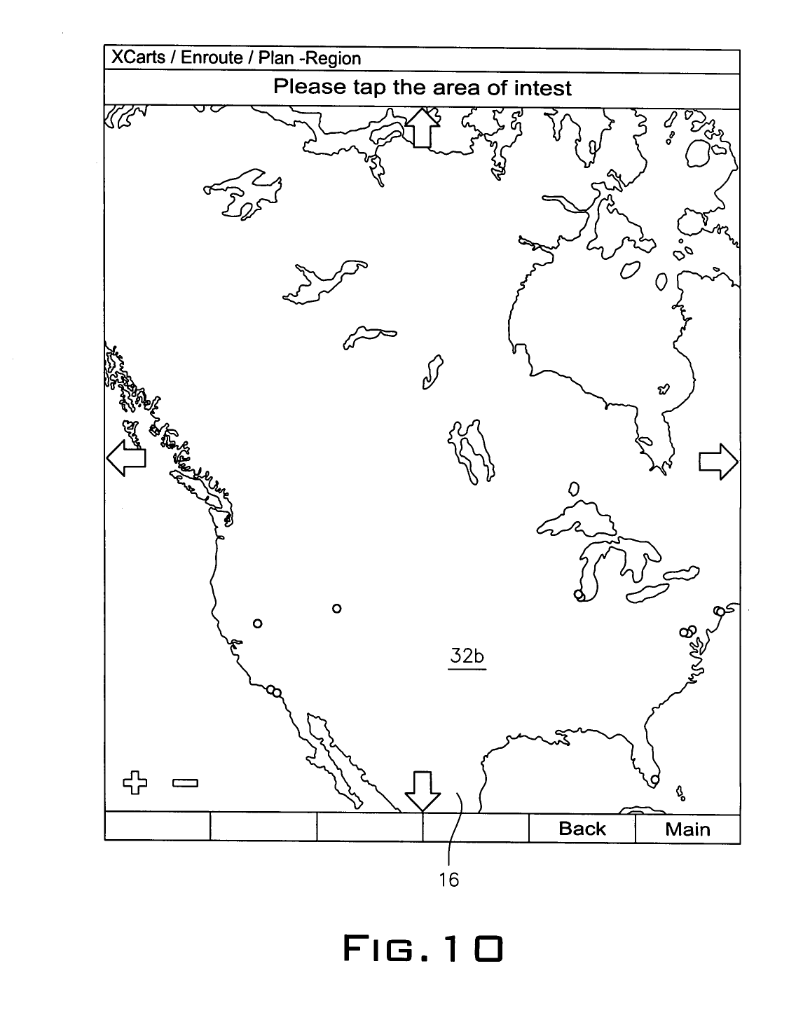

As depicted by way of example in FIGS. 9 and 10, Plan Mode lets the pilot view charts for areas that do not contain the location of the aircraft. Therefore, chart centering and moving is turned off and the aircraft's position is not visible. The charts are selected by “drilling down” through a series of charts and zooming in until the location is clearly visible.

Selecting a Viewing Area: From the Charts Main Menu, touch the Enroute Plan button. This brings up the world map as depicted in FIG. 9. Tap a continent to bring up a smaller region of the world, for example, North America (see FIG. 10).

The origin and destination airports for the current flight are marked with magenta dots, while all company airports are marked with brown dots. The zoom controls (the plus and minus buttons) are available on the region chart to move in for a closer look. The image can be scrolled by tapping or pressing and holding any of the four black arrows along the edges of the image.

Tap an area on the region chart to drill down further. This will open the Enroute high altitude chart for that area, centered on the location that was tapped.

Focusing the View: The origin and destination airports for the current flight are automatically marked by highlighting their airport codes in magenta. Other company airports are highlighted in brown. Zoom in and the origin and destination airport codes are written on the chart in magenta. Other company airports are written in brown.

### Button Controls

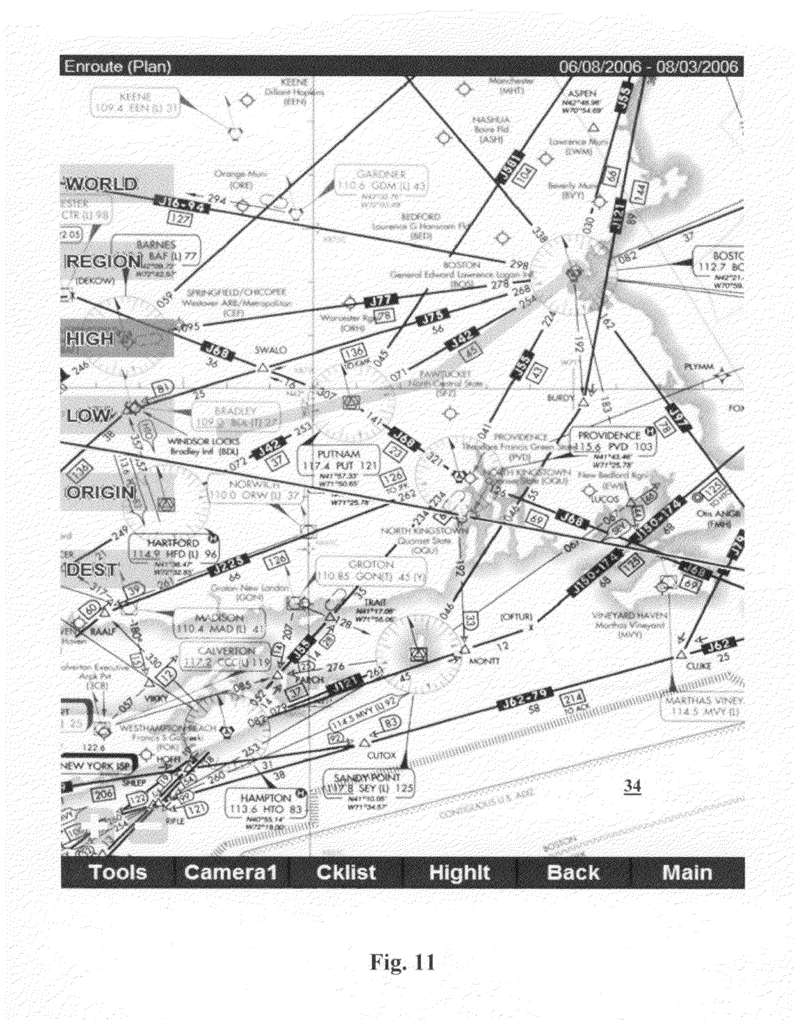

As shown in FIG. 11, there are seven translucent tabs located along the left side of the Enroute chart display. Touch any of these tabs to switch to different screens. The first four tabs show different Enroute chart views: World, Region, High altitude, Low altitude. The next two tabs show the currently selected plates for the origin and destination airports, and the last tab shows the currently selected plate for the alternate airport, if an alternate airport was selected.

Zooming: The Zoom feature for Enroute charts is the same as the zoom feature for terminal procedure plates. The image enlargement varies in a series of small steps with the highest zoom level 4 times bigger than the lowest zoom level. Press and hold a finger on the plus or minus button for a continuous and smooth zoom.

Camera: Touch the Camera button to view the video feed from one or more cameras on the plane.

Checklist: Touch the “Cklist” button to view the EFB's Procedural Checklist.

Panning: To see other parts of the chart, touch and drag the image to the desired position. Note: When the chart is panned in View mode, chart centering is temporarily suspended. The suspension remains in effect as long as the user is actively manipulating the chart display. Automatic chart centering and movement resumes 15 seconds after the last action to control the display.

Highlighting: A highlighting tool is provided for the purpose of highlighting routes on Departure Plates, arrival Plates, Taxi Charts and Enroute Charts. A highlighted route is a connected sequence of straight lines joined by a ball at each vertex. The highlighting tool is not available on Approach Plates, Company Plates, World Maps or Regional Maps. While using the highlighting tool, the pilot is restricted to drawing the route on one type of “canvas”. For example, a highlighted route may be drawn over several High Altitude Charts or several Low Altitude Charts, but never over a High Altitude Chart and a Low Altitude Chart. For the purposes of highlighting, the following canvases are recognized: The union of all High Altitude Enroute Charts; The union of all Low Altitude Enroute Charts; One Taxi Chart; One Departure Plate; One Arrival Plate. Only one highlighted route can be drawn on each canvas at a time.

Highlighting can be used in both View and Plan modes. To highlight a route on a canvas: Load a plate or chart. The “Highlt” button will be visible at the bottom of the screen. Touch the “Highlt” button. The EFB is now in Highlight mode. Tap a location on the screen. A green ball will mark the tapped spot. Tap the next location in the route. The green puck will appear where the second tap occurred and a magenta line will join the two tapped locations. Continue adding legs to the route in this manner. A highlighted route can be adjusted after it has been made; touch and drag any vertex to a different location. When finished highlighting and adjusting the route, touch “Done”.

Panning: When Highlighting is turned on, touch-and-drag panning is disabled. Touch the black arrow buttons along the edges of the screen to scroll the plate or chart while drawing a route,

Zooming: The plus and minus buttons are available as usual during Highlighting mode. Use them to zoom in and out and fine tune the route. Press and hold the zoom buttons for a smooth, continuous zoom.

BKSP (Backspace): Touch BKSP to erase the last segment of the highlighted route.

Clear: Touch Clear to erase the entire highlighted route.

### Takeoff Minimums

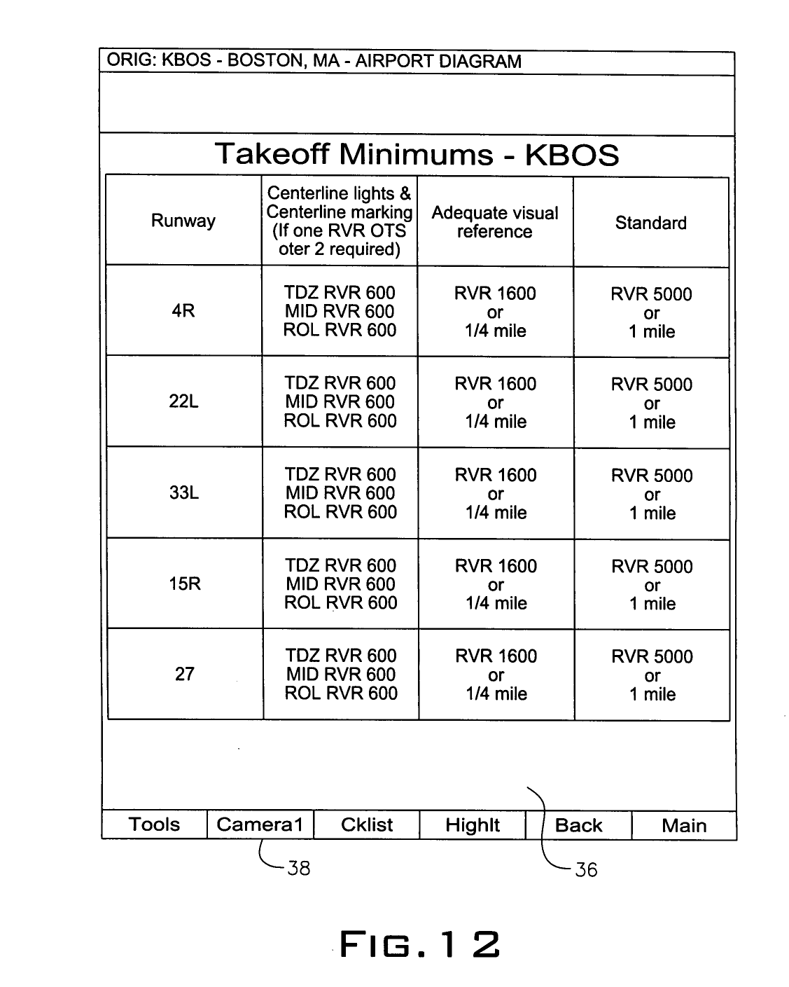

The pilot may need to review takeoff minimum values before beginning a flight. See FIG. 12 for an example of such a chart for Logan Airport in Boston. These values are maintained and distributed in a database by the airline. The EFB software generates a plate display of takeoff minimums for a given airport. To view the takeoff minimums for an airport, touch the Airport Diagram Tab, then touch the Next tab.

### Runway Notes

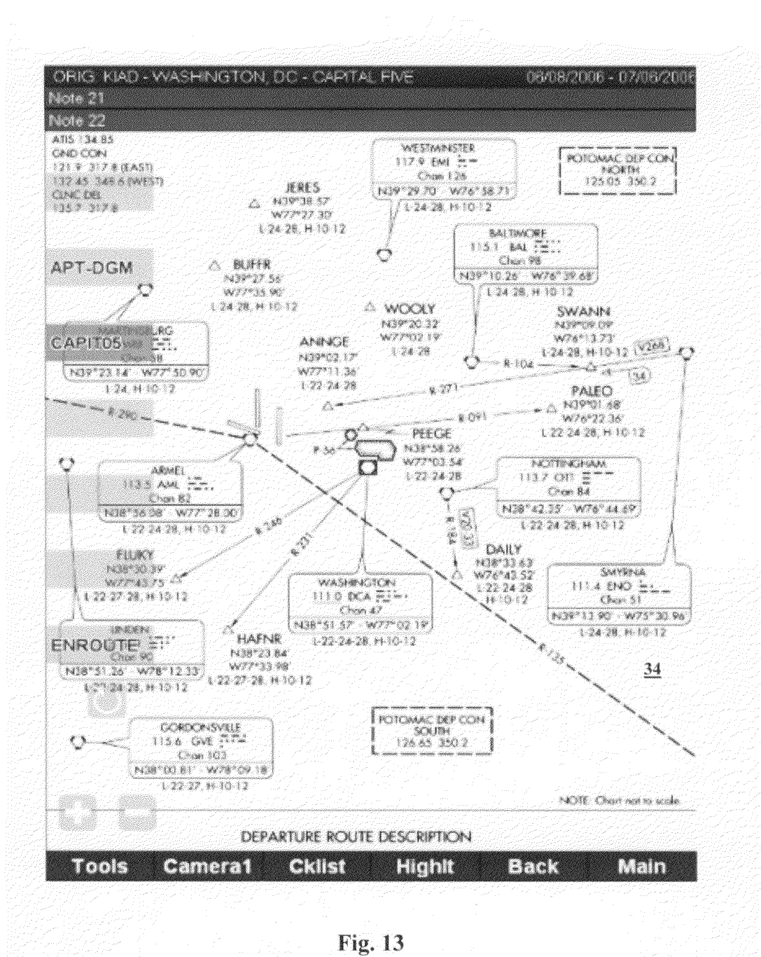

FIG. 13 is an example of a diagram with the option of obtaining runway notes. Runway notes, if available, will appear in brown boxes at the top of the departure plate display. Press a box to read the corresponding note. In the example, the diagram is showing the option to choose Note 21 or Note 22.

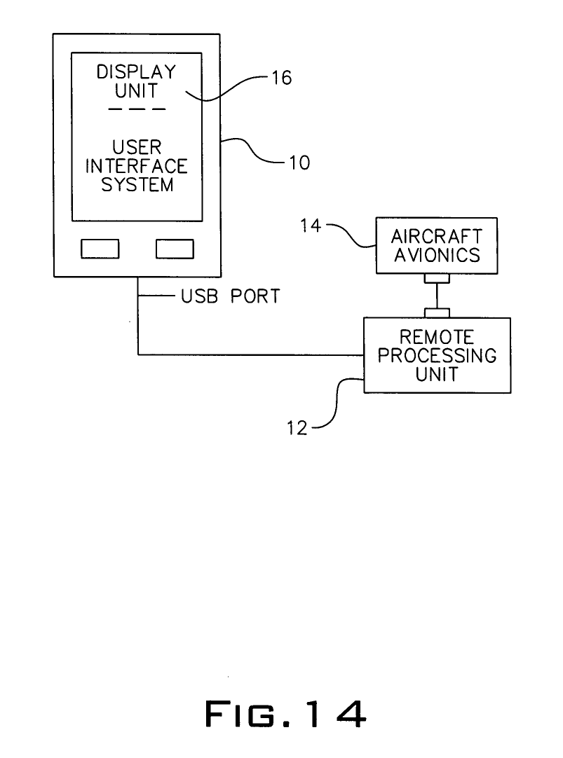

FIG. 14 is a conceptual schematic of one example of the display unit in electronic communication with a processing unit and ship's avionics system using a USB port connection. The display unit is however generally connected to a remote processor unit (RPU) using a Low Voltage Differential Signal (LVDS) or fiber optic connections and the system operates as an airline avionics system rather than a Personal Computer (PC).

From the description above, the invention is an electronic flight bag user interface system comprising:

a multi-function flight information display unit 10 adapted to be in electronic communication with a remote processing unit 12, the processing unit 12 being adapted to be in electronic communication with an aircraft avionics system 14;

means for displaying flight information on said multi-function flight information display unit (the display screen 16);

the processing unit 12 further comprising means for pre-loading said flight information; and

the processing unit 12 comprising means for selectively displaying said flight information on said display unit in digital electronic format, including charts and plates 16a, flight manuals or papers 16e, weather information 16d, camera viewing information 16c, ship library information 16b, and revision status 16f of said software programmed in said processing unit 12 and revision status 16f of said charts, plates and manuals.

The charts and plates flight information further comprises information related to flight origin information 18, flight destination information 20, flight enroute information 22 and alternate airport information 24.

The display unit 16 is programmed to display a virtual keyboard 26, which serves as means for selecting an airport, when charts and plates flight information is selected for display.

The processing unit 12 can run two separate operating systems, for example, one based on a Windows® based operating system and the other based on a DO178B operating system. It is understood that it can run solely on the Windows® based operating system, as well.

The charts and plates information comprises:

airport diagrams 28 and runways 30 for origin, destination and alternate airports;

world 32a and regional 32b enroute information, including flight navigational information 34 between origin and destination airports.

The system further comprises means 36 for selectively displaying takeoff minimum data for selected airports.

When using the charts and plates flight information, the system comprises means for displaying terminal procedure plates, including standard terminal arrivals, instrument approach procedures, taxi diagrams, departure procedures, and airline provided data.

The system further comprises means for viewing on the display unit 16 a video feed from predetermined selectable cameras 38 on an aircraft.

The system also has means 40 for highlighting routes on the charts and plates.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

1. An electronic flight bag user interface system comprising:
a multi-function flight information display unit adapted to be in electronic communication with a remote processing unit, said processing unit being adapted to be in electronic communication with an aircraft avionics system;
means for displaying flight information on said multi-function flight information display unit;
said processing unit further comprising means for pre-loading said flight information; and
said processing unit comprising means for selectively displaying said flight information on said display unit in digital electronic format, including charts and plates, flight manuals, weather information, camera viewing information, ship library information, and revision status of said software programmed in said processing unit and revision status of said charts, plates and manuals.

2. The system according to claim 1, wherein said charts and plates flight information further comprises information related to flight origin information, flight destination information, flight enroute information and alternate airport information.

3. The system according to claim 1, wherein said display unit is programmed to display a virtual keyboard, which serves as means for selecting an airport, when charts and plates flight information is selected for display.

4. The system according to claim 1, wherein said processing unit runs on a Windows® based operating system, a DO178B certified operating system or a combination of said Windows® based operating system and said DO178B certified operating system.

5. The system according to claim 2, wherein said charts and plates information comprises:
airport diagrams and runways for origin, destination and alternate airports;
world and regional enroute information, including flight navigational information between origin and destination airports.

6. The system according to claim 3, further comprising means for selectively displaying takeoff minimum data for selected airports.

7. The system according to claim 2, wherein when using said charts and plates flight information, the system comprises means for displaying terminal procedure plates, including standard terminal arrivals, instrument approach procedures, taxi diagrams, departure procedures, airline provided data.

8. The system according to claim 1, further comprising means for viewing on said display unit a video feed from predetermined selectable cameras on an aircraft.

9. The system according to claim 5, further comprising means for highlighting routes on said charts and plates.
